(19) United States
(12) Patent Application Publication
(10) Pub. No.: US 2026/0100116 A1
(43) Pub. Date: Apr. 9, 2026

(54) AUTOMATIC CONTROLS FOR ELECTROMECHANICAL SIREN

(71) Applicant: Hot Canyon LLC, Gilbert, IA (US)

(72) Inventors: Josh Bennett, Gilbert, IA (US); Ty Sopko, Rock Island, IL (US)

(21) Appl. No.: 19/349,264

(22) Filed: Oct. 3, 2025

Related U.S. Application Data
(60) Provisional application No. 63/702,935, filed on Oct. 3, 2024.

(51) Int. Cl. G08B 3/10; G10K 7/04

(52) U.S. Cl. CPC G08B 3/10; G10K 7/04

(57) ABSTRACT

A system for controlling an electromechanical siren is disclosed. The system includes an electromechanical siren comprising a siren and an electric motor, an automatic operation switch, and one or more processors. When a user activates the automatic operation switch from an open position to a closed position, the one or more processors activate the electric motor such that the electric motor drives the siren of the electromechanical siren. The processors allow the electric motor to run for a first non-zero duration of time, and, while the automatic operation switch remains in the closed position, and after the expiration of the first non-zero duration of time, deactivate the electric motor such that the electric motor ceases to drive the siren of the electromechanical siren.

### RELATED APPLICATIONS

This application claims the benefit of U.S. Provisional Application No. 63/702,935, filed Oct. 3, 2024, the entire contents of which are incorporated herein by reference.

### TECHNICAL FIELD

The disclosure relates to electromechanical sirens.

### BACKGROUND OF THE INVENTION

A typical electromechanical siren consists of a motor, coaster clutch, brake assembly, intake grille, and a rotor plus stator assembly. The final two components create the audible warning once the rotor is brought into motion, pulling air through the intake grille and forcing it out the stator slots. The siren motor and brake are electrically operated. In one example, the brake may be a solenoid that physically connects a friction plate or clutch to the rotor to bring it to a stop.

A typical embodiment would consist of a power source (such as a vehicle battery or charging system), two switches to control electric current flow to the integral motor and brake, fuses for wire protection, and appropriate wiring. An optional solenoid switch is often used. It is placed with its switch contacts near the battery and siren, localizing the heavier gauge wire and keeping it short to reduce cost, weight, and simplify assembly. The solenoid coil is energized by lighter gauge wire which completes a circuit containing a battery and control switch. The control switch, like the brake solenoid switch, is located in the vehicle cab.

Operation of the siren and its brake are performed manually by an operator. Furthermore, in many instances, proper protocol is to run the siren for a particular amount of time, and then stop powering the siren for another particular amount of time to make the sound more noticeable. The operator is also responsible for driving the vehicle safely while oscillating the power to the siren, such that additionally operating the siren poses a cognitive burden.

### SUMMARY OF THE INVENTION

In general, the disclosure relates to a control system for an electromechanical siren, such as those installed on emergency vehicles and storm siren poles. The control system includes an automatic operation switch and a computing device that includes at least one or more processors. When a user activates the automatic operation switch from an open position to a closed position, the one or more processors activate the electric motor such that the electric motor drives the siren of the electromechanical siren. The processors allow the electric motor to run for a first non-zero duration of time, and, while the automatic operation switch remains in the closed position, and after the expiration of the first non-zero duration of time, deactivate the electric motor such that the electric motor ceases to drive the siren of the electromechanical siren. The electric motor stays deactivated for a second non-zero duration of time, after which, if the automatic operation switch is still closed, the one or more processors will reactivate the electric motor, repeating the process until the automatic operation switch opens.

As this control system operates to control existing electromechanical sirens, vehicles and systems that utilize electromechanical sirens need not remove the entire siren in order to achieve automatic operation. Rather, the control system described herein can be installed to operate with the existing electromechanical sirens, expanding the number of systems that can benefit from the automatic operation. This is especially the case with older emergency vehicles, where many operators prefer the classic sound and appearance of the electromechanical sirens.

By automatically controlling the sirens in the manner described, the systems described herein may reduce operator fatigue by freeing the driver to flip a single switch one time and then focus on the other operating aspects of driving the vehicle. These systems may further operate in accordance with timing protocols for individual jurisdictions without needing to perform manual or mental timing. Furthermore, with the incorporation of processors into the operation procedure, the systems described herein may perform diagnostics on the system, reporting to the user when an issue or error exists within the system such that the user may limit troubleshooting the issues.

In one example, the disclosure is directed to a system including an electromechanical siren comprising a siren and an electric motor. The system further includes an automatic operation switch. The system also includes one or more processors configured to, when a user activates the automatic operation switch from an open position to a closed position, receive an indication of the automatic operation switch being activated into the closed position. In response to receiving the indication of the automatic operation switch being activated, the one or more processors are further configured to activate the electric motor such that the electric motor drives the siren of the electromechanical siren and allow the electric motor to run for a first non-zero duration of time. While the automatic operation switch remains in the closed position, and after the expiration of the first non-zero duration of time, the one or more processors are also configured to deactivate the electric motor such that the electric motor ceases to drive the siren of the electromechanical siren and allow the electric motor to stay deactivated for a second non-zero duration of time.

In another example, the disclosure is directed to a method comprising providing an electromechanical siren comprising a siren and an electric motor, providing an automatic operation switch, receiving, by one or more processors, an indication that a user has activated the automatic operation switch from an open position to a closed position, in response to receiving the indication of the automatic operation switch being activated into the closed position, activating the electric motor such that the electric motor drives the siren of the electromechanical siren, allowing the electric motor to run for a first non-zero duration of time, while the automatic operation switch remains in the closed position, and after the expiration of the first non-zero duration of time, deactivating the electric motor such that the electric motor ceases to drive the siren of the electromechanical siren, and allowing the electric motor to stay deactivated for a second non-zero duration of time.

In another example, the disclosure is directed to a non-transitory computer-readable storage medium containing instructions. The instructions, when executed, cause one or more processors to receive an indication that a user has activated an automatic operation switch from an open position to a closed position, in response to receiving the indication of the automatic operation switch being activated into the closed position, activate an electric motor such that the electric motor drives a siren of an electromechanical siren, allow the electric motor to run for a first non-zero duration of time, while the automatic operation switch remains in the closed position, and after the expiration of the first non-zero duration of time, deactivate the electric motor such that the electric motor ceases to drive the siren of the electromechanical siren, and allow the electric motor to stay deactivated for a second non-zero duration of time.

In another example, the disclosure is directed to a device configured to perform any of the techniques described herein.

In another example, the disclosure is directed to an apparatus comprising means for performing any of the techniques described herein.

In another example, the disclosure is directed to a system of devices for performing any of the techniques described herein.

In another example, the disclosure is directed to any of the techniques described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIGS. 1A and 1B illustrate representatives view of the present disclosure according to some examples, in accordance with one or more techniques of the disclosure. An isometric front view (FIG. 1A) and front view (FIG. 1B) are presented showing integral switches and an indicator.

FIG. 2 is a block diagram illustrating a more detailed example of a computing device configured to perform the techniques described herein.

FIGS. 3A and 3B illustrate representative views of the present disclosure with two examples, in accordance with one or more techniques of the disclosure. An isometric rear view of both are presented, illustrating the similarities of the examples.

FIG. 4 illustrates a representative view of the present disclosure according to some examples, in accordance with one or more techniques of the disclosure. A top-down view is presented showing external connections for the three switches and indicator.

FIG. 5 illustrates the major electrical components in some examples, showing the external connections to the siren and vehicle system, in accordance with one or more techniques of the disclosure.

FIG. 6 illustrates an electrical block diagram of some examples, showing the internal connections only, in accordance with one or more techniques of the disclosure.

FIG. 7 is a flow diagram illustrating an example method for automatically controlling an electromechanical siren, in accordance with one or more techniques of the disclosure.

FIG. 8 is a representative view of potential environments in which a control system may be installed, in accordance with one or more techniques of the disclosure.

FIG. 9 through FIG. 13 illustrate an expansive flowchart that depicts the typical operating behavior of the firmware in the siren driver, in accordance with one or more techniques of the disclosure.

FIGS. 14A through 14D illustrate a sequence of events for normal operation and faulted operation, in accordance with one or more techniques of the disclosure.

FIG. 15 through FIG. 17 illustrate flowcharts that depict error states that could be experienced by the siren driver, in accordance with one or more techniques of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

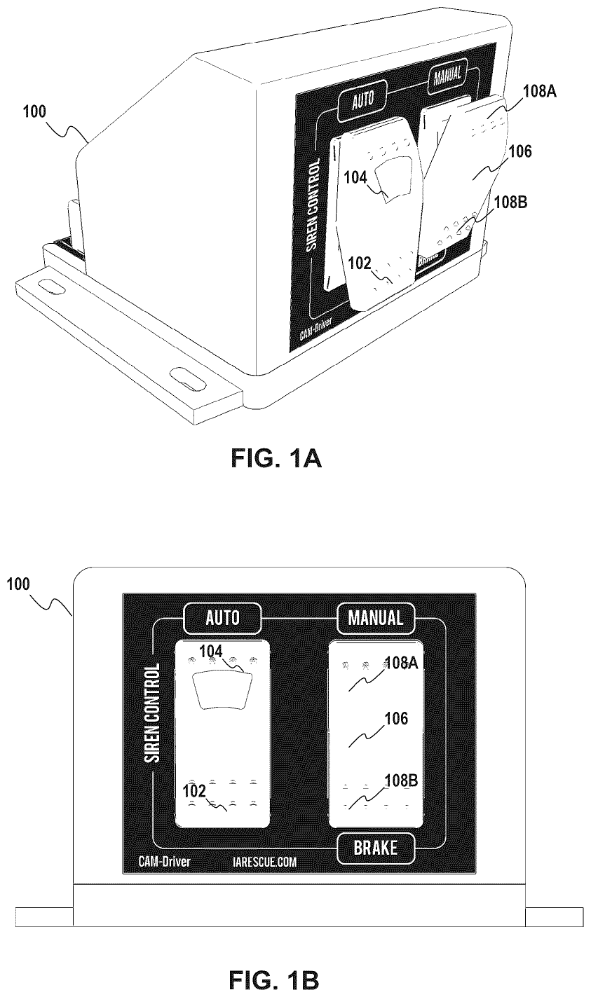

FIGS. 1A and 1B illustrate representatives view of the present disclosure according to some examples, in accordance with one or more techniques of the disclosure. An isometric front view (FIG. 1A) and front view (FIG. 1B) are presented showing integral switches and an indicator.

Referring initially to FIG. 1, one example 100 of this disclosure is presented containing automatic operation switch 102, operation indicator 104, and a center-off, dual function switch 106 (also referred to as “manual operation switch 106”). This switch replaces two discrete switches, closing up for manual siren operation 108A or closing down for brake operation 108B. Inside example 100, or communicatively connected to example 100, may be a computing device, such as computing device 210, to analyze the various positions of automatic operation switch 102 and manual operation switch 106.

When automatic operation switch 102 is in the closed position, activating manual operation switch 106 to either the first position (manual siren operation 108A) or the second position (brake operation 108B) causes the automatic operation switch to move into the open position. Conversely, when automatic operation switch 102 is in the open position, activating automatic operation switch 102 to the closed position causes manual operation switch 106 to move into a third position, the center-off position. In other examples, these switches 102 and 106 may be mechanically independent

While shown in this example as a set of mechanical switches in the form of foot pedals, in other instances, automatic operation switch 102 and manual operation switch 106 may be smaller manual switches on a console or dashboard of a vehicle, or may even be a graphical icon within a graphical user interface output on a user interface component.

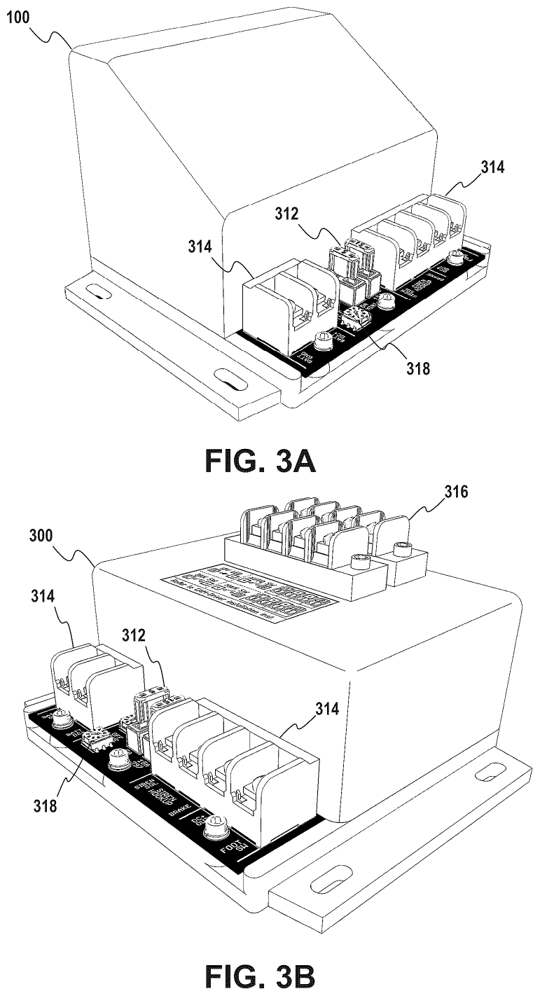

While not shown, example 100 could further include two or more timer switches, wherein a setting of a first timer switch of the two or more timer switches defines a first non-zero duration of time (e.g., a time that the electric motor is activated during an automatic operation cycle), and wherein a setting of a second timer switch of the two or more timer switches defines a second non-zero duration of time (e.g., a time that the electric motor is deactivated during an automatic operation cycle). In some instances, the two or more timer switches may be rotary dual inline package (DIP) switches. For instance, these switches may be similarly located to switches 318 of FIG. 3.

Electromechanical sirens, commonly used in emergency vehicles and stationary emergency notification systems, have traditionally relied on manual operation for their activation and deactivation. This manual control requires operators to oscillate the siren's power to create the desired audible pattern, often adhering to specific timing protocols established by jurisdictions. While effective in generating the necessary warning signals, this approach places a considerable cognitive demand on operators, particularly in high-stress environments such as emergency response scenarios. Operators are required to manage the siren's operation while simultaneously focusing on other tasks, such as navigating traffic or addressing emergencies. This dual responsibility increases the probability of human error, potentially affecting safety and operational efficiency. Furthermore, conventional systems lack integrated diagnostic capabilities, making it challenging to identify and address faults such as stuck switches, short circuits, or overcurrent conditions, which can result in system failures or reduced siren longevity.

The described system addresses these limitations by introducing an advanced control mechanism for electromechanical sirens that automates their operation while incorporating diagnostic and protective features. Central to the solution is an automatic operation switch and a computing device equipped with one or more processors. When the automatic operation switch is activated, the system autonomously manages the siren's activation and deactivation based on predefined timing intervals, reducing the need for continuous manual intervention. This automation not only alleviates operator fatigue but also facilitates adherence to jurisdictional timing protocols without requiring manual or mental timing. The system also includes a manual operation switch for overriding the automatic mode, offering operators the ability to take direct control when needed.

In addition to automation, the described system incorporates advanced diagnostic capabilities. The processors analyze the system's circuitry to compare the current state with expected configurations, enabling the detection of faults such as stuck switches, short-to-ground conditions, and overcurrent scenarios. Protective mechanisms, such as a normally closed relay, are included to mitigate the impact of specific electronic failures, such as a stuck foot switch. For instance, when the foot switch remains continuously activated for a predetermined duration, the relay disconnects the switch from the siren solenoid, preventing unintended continuous operation. Similarly, the system includes a brake solenoid lockout feature that enforces a duty cycle to prevent overheating and extend the lifespan of the brake solenoid.

By combining automation, diagnostics, and protective features, the described system significantly enhances the reliability, safety, and usability of electromechanical sirens. The system's architecture, which integrates specialized algorithms and configurable timing mechanisms, ensures seamless operation while providing operators with actionable insights into system health. This represents a substantial improvement over conventional approaches, addressing longstanding challenges in the domain of electromechanical siren control.

The techniques described herein include an automated control system for electromechanical sirens, designed to address the operational and diagnostic challenges inherent in traditional manual siren systems. The system integrates an automatic operation switch, a manual operation switch, one or more processors, and protective hardware elements such as a normally closed relay and brake solenoid lockout mechanisms. Upon activation of the automatic operation switch, the processors autonomously manage the siren's activation and deactivation according to configurable timing intervals, thereby reducing operator workload and ensuring compliance with emergency signaling protocols.

An aspect of the techniques described herein is the advanced diagnostic capability, which enables the system to monitor and analyze the state of switches and circuitry, detect faults such as stuck switches, short-to-ground conditions, and overcurrent events, and respond with appropriate protective actions. For example, the system can disconnect a failed foot switch from the siren solenoid using a relay, and can enforce a duty cycle on the brake solenoid to prevent overheating and extend component life. The system also provides visual indicators to communicate operational status and fault conditions to the user.

By combining automated control, real-time diagnostics, and hardware-based protection, the inventive concept delivers a robust, reliable, and user-friendly solution for electromechanical siren operation in emergency vehicles and stationary notification systems. This represents a significant advancement over conventional manual systems, offering improved safety, reduced operator fatigue, and enhanced system longevity.

Consider a fire department that operates a fleet of emergency vehicles equipped with classic electromechanical sirens. Traditionally, the vehicle operator must manually control the siren using foot and dashboard switches, toggling the siren on and off in accordance with local emergency signaling protocols. This manual process requires the operator to divide attention between driving, monitoring traffic, and managing the siren's timing, increasing the risk of error and operator fatigue.

With the implementation of the disclosed automated control system, each emergency vehicle is retrofitted with a control module containing an automatic operation switch, a manual operation switch, a microcontroller-based processor, rotary DIP timer switches, a normally closed relay, and a brake solenoid lockout mechanism. When the operator begins an emergency response, they simply activate the automatic operation switch. The system's processor receives this input and initiates a pre-programmed cycle: the siren motor is powered for five seconds, then deactivated for six seconds, repeating this pattern as long as the switch remains engaged. The timing intervals are set using the rotary DIP switches to match local regulations.

If the operator needs to override the automatic cycle (e.g., to signal a specific warning or to stop the siren immediately), they can use the manual operation switch. The system instantly responds, allowing direct control of the siren and brake solenoid. Should the foot switch fail and remain stuck in the closed position, the processor detects this condition and opens the normally closed relay, disconnecting the faulty switch from the siren solenoid to prevent continuous siren operation.

Throughout operation, the system continuously monitors the status of all switches and electrical connections. If a fault such as a stuck brake switch, short-to-ground, or overcurrent is detected, the processor triggers a visual indicator on the dashboard, flashing in a distinct pattern to alert the operator. In the case of a stuck brake switch, the system enforces a lockout period, deactivating the brake solenoid for a cooldown interval to prevent overheating and component damage.

This real-life implementation streamlines emergency siren operation, reduces cognitive load on vehicle operators, and enhances the reliability and safety of the siren system. The fire department benefits from improved compliance with signaling protocols, reduced maintenance costs due to extended component life, and increased operator focus on critical driving and response tasks.

The techniques described herein are directed to the automated control and diagnostic management of electromechanical sirens. The system integrates physical components, such as electromechanical sirens, electric motors, switches, relays, and brake solenoids, with one or more processors configured to execute specific control and diagnostic functions. The processors are programmed to receive input signals, actuate physical devices, monitor operational states, and implement protective measures in response to detected faults or abnormal conditions.

This integration of hardware and software produces a tangible improvement in the operation of electromechanical sirens, providing benefits such as reduced operator fatigue, enhanced safety, increased reliability, and extended component life. The system is rooted in the physical manipulation of real-world devices and the resolution of technical problems associated with manual siren operation and fault management.

The techniques described herein apply specific algorithms and control logic to achieve a technical solution, including automated timing cycles, fault detection, and protective relay actuation, all of which result in concrete actions affecting the operation of electromechanical sirens. These features show that the techniques described herein are directed to a machine or process that provides a useful and practical application in the field of emergency signaling and notification systems. The techniques described herein are directed to a specific and useful improvement in the technical field of electromechanical siren control.

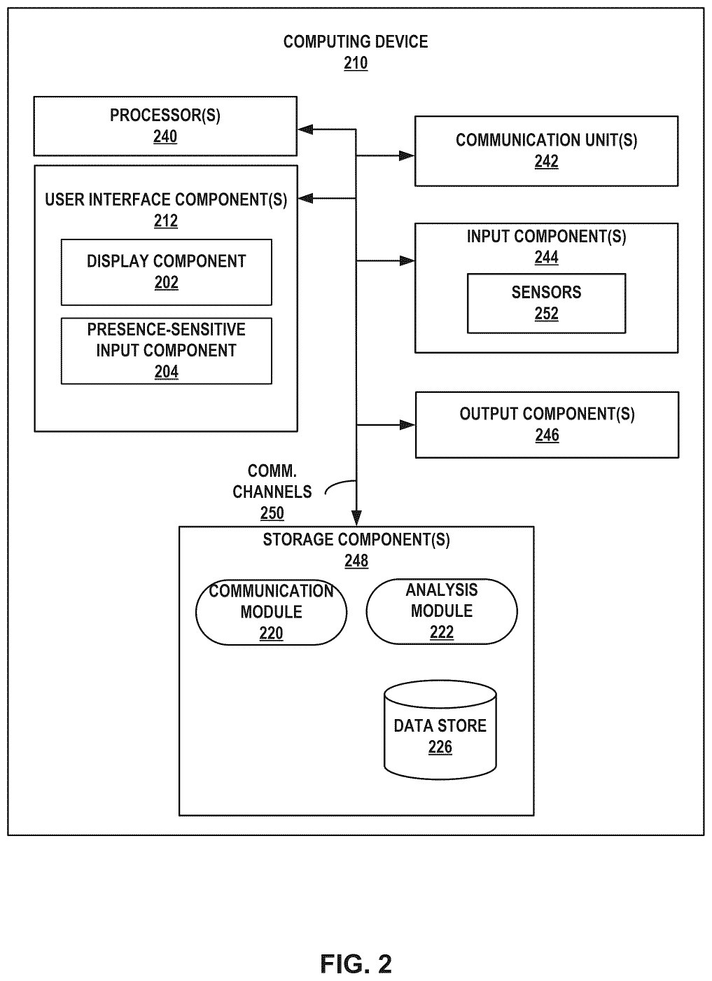

FIG. 2 is a block diagram illustrating a more detailed example of a computing device configured to perform the techniques described herein. Computing device 210 of FIG. 2 is described below as an example of a computing device that could be integrated into, or in communication with, example system 100 described above with respect to FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. For example, computing device 210 may be a microcontroller or microprocessor integrated into a pedal system control box (e.g., example systems 100 and 300 of FIGS. 1 and 3, respectively).

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to control electromechanical sirens. That is, processors 240 may implement functionality and/or execute instructions associated with computing device 210 to open and close circuits for powering an electromechanical sensor automatically when an automatic operation switch is activated.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to open and close circuits for powering an electromechanical sensor automatically when an automatic operation switch is activated.

Communication module 220 may execute locally (e.g., at processors 240) to provide functions associated with receiving indications of input from the system and controlling circuits to activate and deactivate various components. In some examples, communication module 220 may act as an interface to a remote service accessible to computing device 210. For example, communication module 220 may be an interface or application programming interface (API) to a remote server that receives indications of input from the system and controls circuits to activate and deactivate various components.

In some examples, analysis module 222 may execute locally (e.g., at processors 240) to provide functions associated with tracking timing of signals and circuit adjustments made by communication module 220. In some examples, analysis module 222 may act as an interface to a remote service accessible to computing device 210. For example, analysis module 222 may be an interface or application programming interface (API) to a remote server that tracks timing of signals and circuit adjustments made by communication module 220.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, computing device 210 may be integrated into a system with an electromechanical siren, comprising a siren and an electric motor, and an automatic operation switch. This system may be installed in an emergency vehicle or a stationary emergency notification system (e.g., a storm siren). In some instances, the automatic operation switch is not electrically coupled directly to the electric motor.

When a user activates the automatic operation switch from an open position to a closed position, communication module 220 may receive an indication of the automatic operation switch being activated into the closed position. In response to receiving the indication of the automatic operation switch being activated, communication module 220 may activate the electric motor (e.g., such as by electrically or mechanically closing a circuit between a power source and the electric motor) such that the electric motor drives the siren of the electromechanical siren. Analysis module 222 may allow the electric motor to run for a first non-zero duration of time.

While the automatic operation switch remains in the closed position, and after the expiration of the first non-zero duration of time, communication module 220 may deactivate the electric motor (e.g., such as by electrically or mechanically opening a circuit between a power source and the electric motor) such that the electric motor ceases to drive the siren of the electromechanical siren. Analysis module 222 may allow the electric motor to stay deactivated for a second non-zero duration of time. In some instances, the first non-zero duration of time and the second non-zero duration of time are defined by emergency operational standards. In other instances, these durations may be user defined, such as by entering numbers into a graphical user interface or by setting mechanical switches, such as rotary DIP switches.

In some instances, while the automatic operation switch remains in the closed position, and after the expiration of the second non-zero duration of time, communication module 220 may activate the electric motor such that the electric motor drives the siren of the electromechanical siren. Analysis module 222 may allow the electric motor to run for an additional instance of the first non-zero duration of time, repeating the overall process until the automatic operation switch is deactivated or opened.

In some instances, the integrated system further includes a manual operation switch and one or more brake solenoids. In such instances, while the automatic operation switch is in the open position, when the user places the manual operation switch into a first position, communication module 220 may receive an indication of the manual operation switch being activated into the first position. In response to receiving the indication of the manual operation switch being activated into the first position, communication module 220 may activate the electric motor such that the electric motor drives the siren of the electromechanical siren so long as the manual operation switch remains activated into the first position. When the user places the manual operation switch into a second position, communication module 220 may receive an indication of the manual operation switch being activated into the second position. In response to receiving the indication of the manual operation switch being activated into the first position, communication module 220 may deactivate the electric motor such that the electric motor ceases to drive the siren of the electromechanical siren while the manual operation switch remains in the second position and, in some examples, communication module 220 may further activate at least one of the one or more brake solenoids to slow the siren.

In some instances, analysis module 222 may analyze circuitry of the system and compare a current state of the circuitry to an expected state of the circuitry based on positions of any switch in the system.

In some instances, analysis module 222 may diagnose one or more errors in the system, wherein the one or more errors include any one or more of a stuck switch, a short-to-ground condition, and an overcurrent condition.

In some instances, in place of a timer circuit/mechanism/software module for automatic mode, an audio transducer can provide siren status. For example, the siren solenoid can be powered until a frequency window is reliably detected for a given time period; once that criteria is satisfied, the siren can coast until a similar condition is met for a lower frequency. The siren solenoid would then be powered again.

In some instances, instead of processors 240 implementing functionality, several discrete circuits may power the techniques described herein. For instance, priority encoder ICs (or PAL/PLA ICs) could select an appropriate combination of outputs (solenoid and indicator) based on the switch inputs. An astable multivibrator, oscillator circuit (passive components or digital logic), other type of timer (555/556) or digital counter (e.g. divide-by-N with a 32.768 kHz source), a mechanical timer, or a time-delay relay can provide the X second on/Y second off mechanism (also referred to herein as the first and second time durations) with appropriate glue logic implementing reset, blanking, and hold functions. A switch could also operate at the solenoid output level (possibly with relays) rather than at the user input level. Discrete circuits to implement the same diagnostics, such as a window comparator connected to the load driver current sense feedback. Threshold comparisons generate open circuit and short-to-ground/overcurrent signals.

In some instances, the system may include a normally closed relay electrically coupled between a foot switch and a siren solenoid. In such instances, communication module 220 may open the normally closed relay in response to detecting that the foot switch has remained continuously activated for a predetermined duration.

In some instances, the system may include a brake solenoid and a lockout timer. In such instances, in response to detecting that the brake solenoid has been continuously actuated for a first threshold duration, communication module 220 may deactivate the brake solenoid for a second threshold duration.

In some instances, in response to detecting that the foot switch has transitioned from a continuously activated state to a continuously deactivated state for a predetermined reset duration, analysis module 222 may clear a lockout flag and re-enable actuation of the siren solenoid via the foot switch.

In some instances, in response to detecting that the brake solenoid has been continuously actuated for a third threshold duration exceeding the first threshold duration, analysis module 222 may generate a diagnostic indication of a stuck brake switch and communication module 220 may disable actuation of the brake solenoid until the brake switch is measured open.

In some instances, communication module 220 may adjust the first non-zero duration of time and the second non-zero duration of time based on user input received from rotary switches or a graphical user interface.

In some instances, communication module 220 may monitor a voltage divider circuit to detect undervoltage and overvoltage conditions, and in response to detecting such conditions, deactivate the siren and solenoids to prevent battery drain or component damage.

FIGS. 3A and 3B illustrate representatives view of the present disclosure with two examples, in accordance with one or more techniques of the disclosure. An isometric rear view of both are presented, illustrating the similarities of the examples. FIGS. 3A and 3B depicts one example 100 and another example 300. The presented angle of the illustrations shows the commonality between examples with fuses 312 and a terminal block 314 that connects both examples to the vehicle battery, siren solenoid switch, siren brake solenoid, and foot switch. FIGS. 3A and 3B also show terminal block 318 with additional switches, such as on time and off time rotary switches. The example 300 also depicts two terminal blocks 316 that are used to connect to an external automatic mode switch, indicator, manual siren switch, and brake switch. It should be noted that the differences between examples 100 and 300 are only intended to show the potential different features that could be included in any of the control systems described herein. For the purposes of this disclosure, unless otherwise made explicit, any potential feature may work with and be operable with any other combination of features described herein for an example system

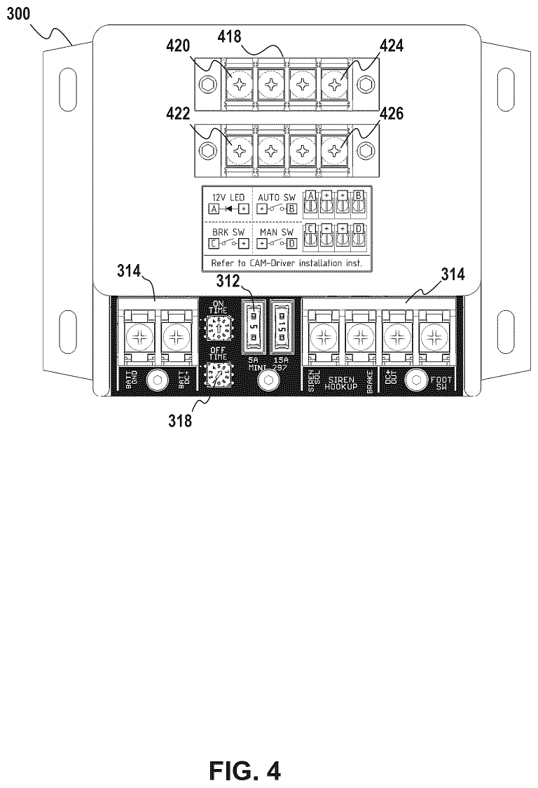

FIG. 4 illustrates a representative view of the present disclosure according to some examples, in accordance with one or more techniques of the disclosure. A top-down view is presented showing external connections for the three switches and indicator. FIG. 4 shows one example 300 in further detail. A clear presentation of fuses 312 and terminal block 314, with silkscreen labels, is shown. Detail of terminal blocks 316 and 318 are also shown. A transient-protected, reverse-battery protected, DC positive center connection 418 is distributed among the inner four terminals. An indicator cathode connection 420, a brake switch connection 422, an automatic mode switch connection 424, and a manual siren switch connection 426 comprise the remaining four terminals.

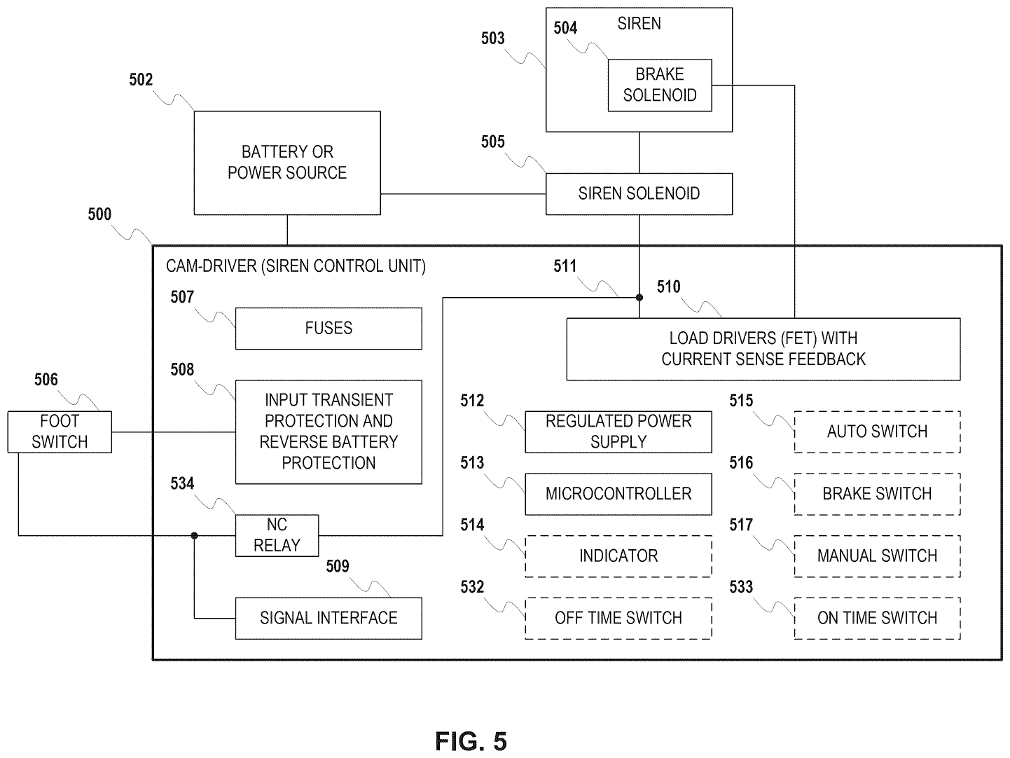

FIG. 5 illustrates the major electrical components in some examples, showing the external connections to the siren and vehicle system, in accordance with one or more techniques of the disclosure. FIG. 5 shows a representative view of the disclosure according to some examples. The siren driver 501 is connected to the vehicle components: a battery 502, a siren 503 whose electrical connections include a brake solenoid 504 and a motor connection via an external siren solenoid switch 505, and a foot switch 506.

Fuses 507 protect the wiring between the siren driver 501 and the external components 504 and 505. The battery 502 is connected to a transient (and load dump) protection circuit and a reverse battery protection circuit, both in 508. A signal interface 509 bridges foot switch 506, automatic mode switch 515, brake switch 516, and manual siren switch 517 to a microcontroller 513. The microcontroller 513, and the signal interface 509, receive voltage from an onboard regulated power supply 512 operating at logic levels. Microcontroller 513 switches on and off the load drivers 510 to power either the siren solenoid switch 505 or brake solenoid 504. The switching mechanism and timing is determined by firmware that is loaded onto microcontroller 513 in some examples, as well as off time switch 532 and on time switch 533. Load switch drivers 510 provide current sense feedback for each solenoid when the respective load driver is actuated. Indicator 514 is lit when automatic mode is turned on, flashes when there is a conflict between switch states that would damage the siren (requested by operator, but inhibited by firmware), or flashes a different pattern for diagnostic reports. FIG. 5 also shows off time switch 532, on time switch 533, and normally closed relay 534. The foot switch 506 is electrically coupled to the siren solenoid 505 through a normally-closed relay 534. This relay provides safety against specific electronic failures of 500 but is opened when the foot switch 506 fails closed for an excessive, specific amount of time as detected by the signal interface 509.

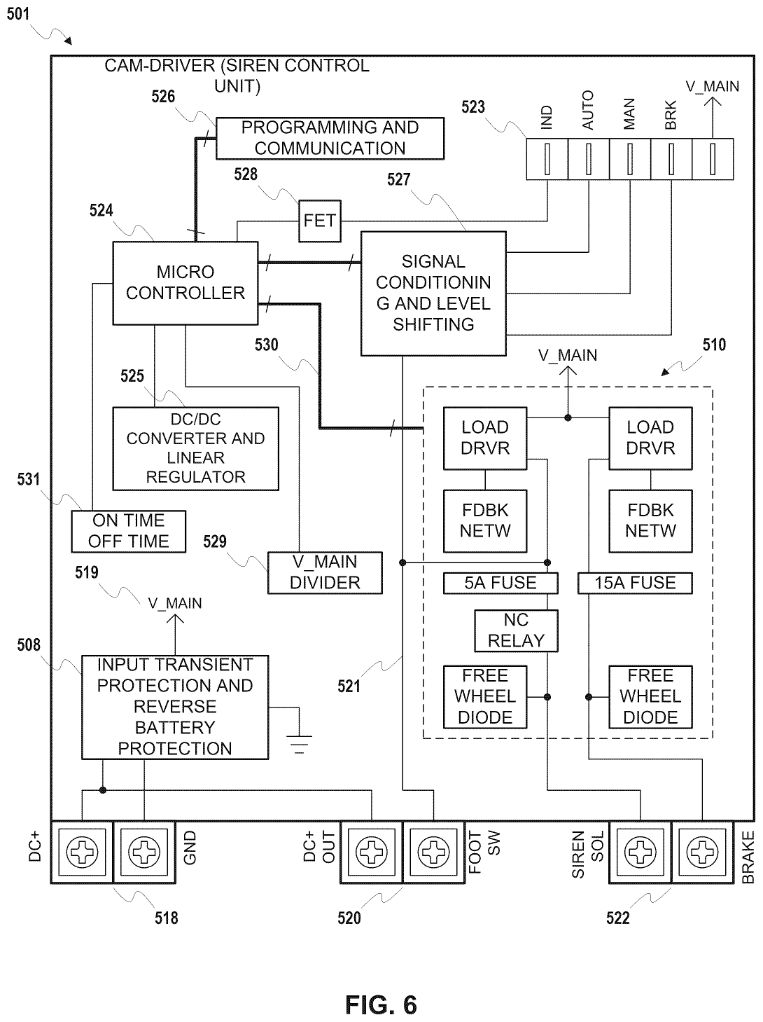

FIG. 6 illustrates an electrical block diagram of some examples, showing the internal connections only, in accordance with one or more techniques of the disclosure. FIG. 6 shows the electrical connections between internal components according to some examples. Siren driver 501 is depicted with all of the internal components from FIG. 5 in additional detail.

A circuit implementing transient protection (and load dump) and reverse battery protection 508 is connected directly to terminal block connections 518. In this example, an internal rail 519, V_MAIN, distributes this conditioned voltage to other internal components. The DC+ connection 518 is tied directly to DC+ out terminal block connection 520 for the external foot switch. The foot switch input 521 connects to both the solid state load driver circuit 510 and the signal conditioning block 527 to allow the firmware running on microcontroller 524 to sample the foot switch input state. The direct connection of 521, through the siren solenoid switch fuse, to terminal block 522 where the siren solenoid switch connects improves operational capabilities under a faulted condition. This circuit may also include an NC relay, which provides a direct electrical connection between the foot switch and the siren solenoid.

One example may contain an internal connection block 523. This block electrically interfaces the circuit board to the panel-mount components on the enclosure, such as the switches and indicator shown in one example 100 or the terminal blocks depicted in example 300.

Microcontroller 524 is powered by the dual-stage DC/DC converter and linear regulator 525, which also provides a rail for signal conditioning circuit 527. Programming and communication headers 526 are used to load new firmware to microcontroller 524 or capture, via an electronic communication bus, the memory values that represent the electrical state of the product. A FET 528 is driven by the microcontroller to turn the indicator on and off. V_MAIN rail 519 is divided by a circuit 529 to ensure that voltages beyond 48V do not exceed the range of the ADC in microcontroller 524. Circuit 529 is used to detect undervoltage conditions to deactivate the siren to ensure it does not drain the battery and to detect overvoltage conditions to protect the siren and solenoids. For example, if a 12V vehicle is undergoing a 24V jumpstart as described by SAE, the siren should remain inert until the 24V source is removed.

Solid state load drivers and support circuits 510 exchange electrical data with microcontroller 524 through bus 530. Bus 530 contains: two signals output from microcontroller 524 to close or open each solid state switch, and a feedback network that provides two analog voltages to microcontroller 524 that change proportionally to the current flowing through the load connected to each driver (including an open circuit with no current).

Two fuses are depicted with the solid state driver circuit 510, protecting the siren and brake solenoid wires connected to 522. Two freewheeling diodes prevent damage to the solid state drivers by allowing electromagnetic field collapse of any de-energized solenoid to have a designed path for current.

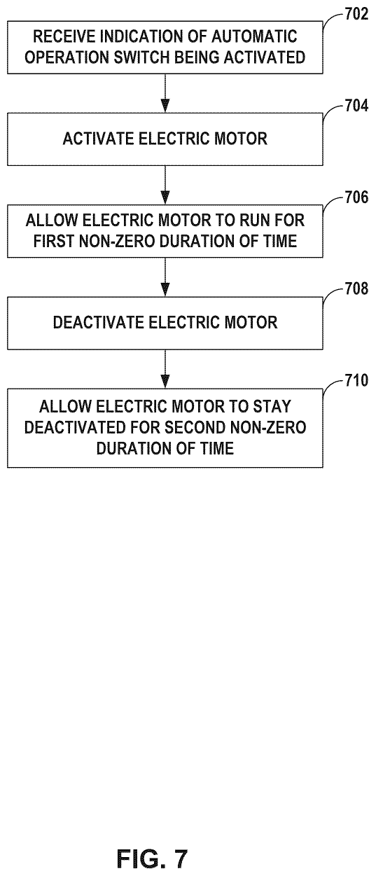

FIG. 7 is a flow chart illustrating an example mode of operation. The techniques of FIG. 7 may be performed by one or more processors of a computing device, such as system 100 of FIG. 1 and/or computing device 210 illustrated in FIG. 2. For purposes of illustration only, the techniques of FIG. 7 are described within the context of computing device 210 of FIG. 2, although computing devices having configurations different than that of computing device 210 may perform the techniques of FIG. 7.

In accordance with the techniques of this disclosure, when a user activates the automatic operation switch from an open position to a closed position, communication module 220 receives an indication of the automatic operation switch being activated into the closed position (702). In response to receiving the indication of the automatic operation switch being activated, communication module 220 activates the electric motor such that the electric motor drives the siren of the electromechanical siren (704). Analysis module 222 allows the electric motor to run for a first non-zero duration of time (706). While the automatic operation switch remains in the closed position, and after the expiration of the first non-zero duration of time, communication module 220 deactivates the electric motor such that the electric motor ceases to drive the siren of the electromechanical siren (708). Analysis module 222 allows the electric motor to stay deactivated for a second non-zero duration of time (710).

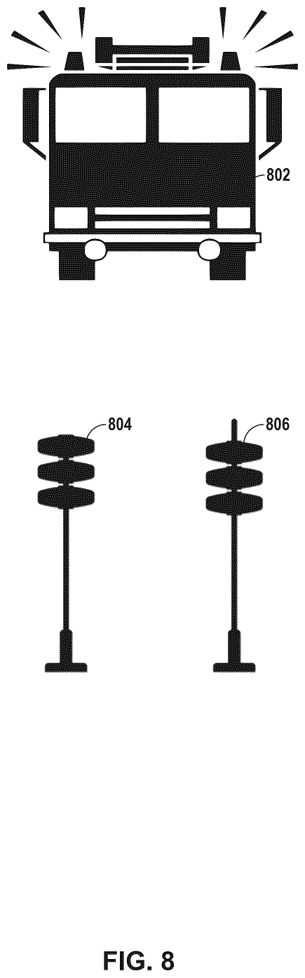

FIG. 8 is a representative view of potential environments in which a control system may be installed, in accordance with one or more techniques of the disclosure. For instance, the system of FIGS. 1 and 2 may be installed in emergency vehicle 802, such as a fire truck, an ambulance, or a police vehicle. The system of FIGS. 1 and 2 may also be installed in storm siren poles, such as poles 804 and 806.

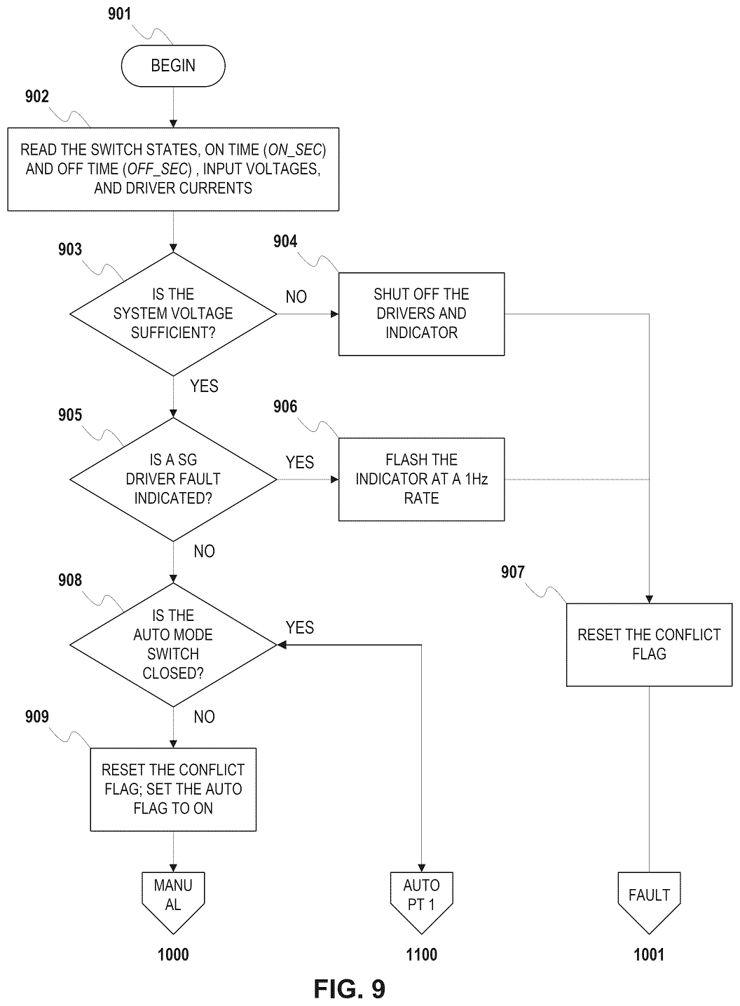

FIG. 9 through FIG. 13 illustrate an expansive flowchart that depicts the typical operating behavior of the firmware in the siren driver according to some examples, in accordance with one or more techniques of the disclosure. FIG. 9 through 13 depict a possible example of the firmware that operates on the microcontroller, though in other instances, the included firmware may differ, including fewer instances of firmware, additional pieces of firmware, or firmware that performs different functions. Several internal state variables are maintained for product operation.

The firmware executes as a task on an RTOS in a periodic manner, starting at point 901. Firmware reads the input switch states, voltages, and driver currents (represented as a voltage), including on time and off time, in 902. After these values are ready, overall operation is decided in 903: a low or high voltage may lead to drivers and indicators shut off in 904.

A conflict flag described in 907 represents when the operator has actuated switches in a way that conflict with the siren operation; this flag is cleared in 907 since switch voltages are not guaranteed to reliably represent actual switch states.

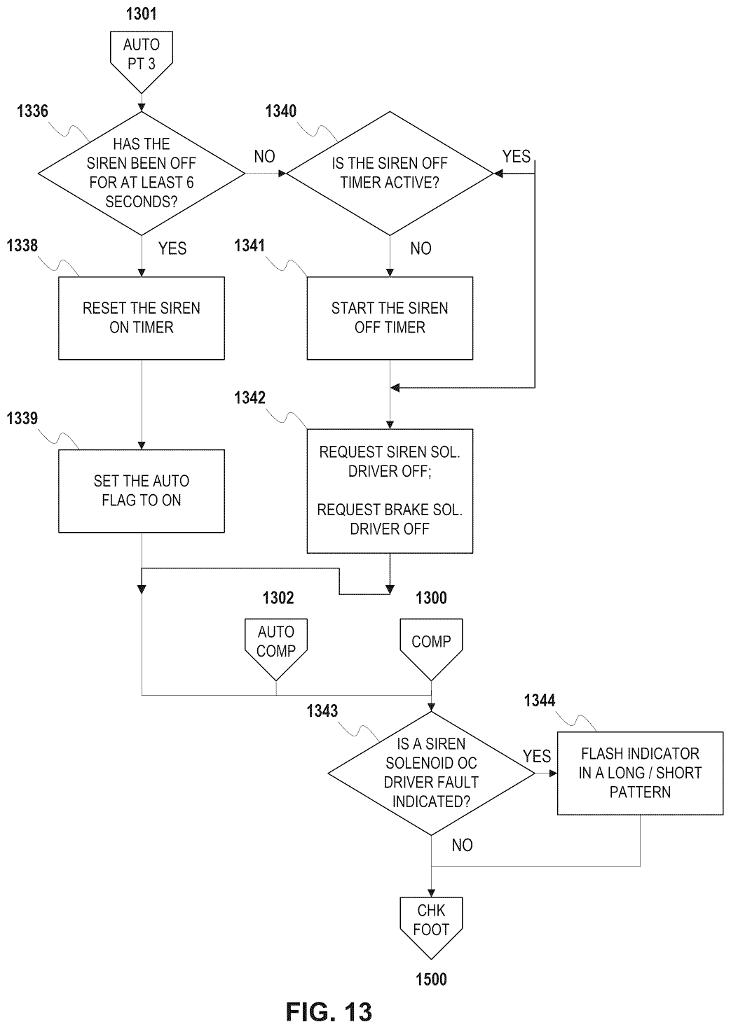

An unreliable voltage leads to conditional test 1343 (in FIG. 13), which may result in the firmware task completing since the drivers have been shut off.

If the system voltage is within the proper range, the voltage returned from the solid state load drivers may be assessed in 905 to determine if a short-to-ground fault is present. In the depicted example, the fault condition is handled entirely by the hardware. The indicator is flashed at a 1 Hz rate in 906.

If no fault is present in 905, the auto mode switch state is determined by measuring the voltage of that input after it has been conditioned and level-shifted. An open auto mode switch exposes the basic functionality of this product and may be examined first.

Since the auto mode switch is open (or has just been opened), the conflict flag is reset in 909. An auto flag, representing whether the auto mode operation is in the 5 second on portion (auto flag=“on”) or 6 second coast/off portion (auto flag=“off”) is set to “on” to ensure that the siren solenoid switch may be closed once the firmware has directed a closing edge on the auto mode switch.

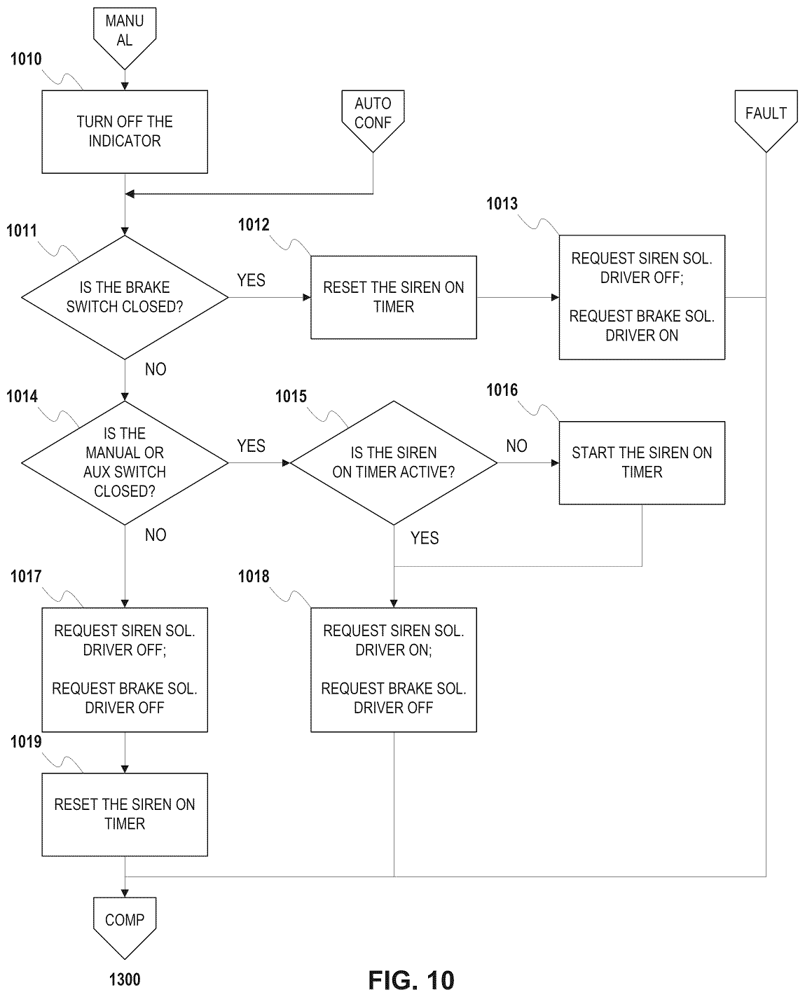

Moving to FIG. 10, the indicator is turned off in 1010 for manual (meaning not automatic) operation of the siren and brake solenoids. The brake switch state is assessed in 1011. If the brake switch is closed, the siren on timer is reset in 1012.

Two timers are used to control how the automatic control transitions between auto flag=“on” and auto flag=“off”—a siren on timer stores the amount of time that the siren has been on, and a siren off timer stores the amount of time that the siren solenoid has been off with siren coasting.

Resetting the siren on timer in 1012 indicates that the siren solenoid switch is about to be opened and the siren may no longer be powered.

Actions in 1013 ensure the siren solenoid switch is off and the brake solenoid is turned on. The final test before ending this task iteration is 1343 (in FIG. 13), which is not applicable in this case. Note that the brake may be prioritized over the siren; this enables a stuck foot switch to be overridden in some examples before the switch can be assessed as stuck.

If the brake switch is not closed in 1011, the manual switch and auxiliary (foot) switch states are checked in 1014. If either is closed, the siren on timer is checked in 1015.

As the described example is an RTOS task, the test performed in 1015 may be checked in regular, periodic intervals.

In a more static example, the check in 1015 may not be necessary.

If the siren on timer is not active (indicating the siren is presently off) in 1015, it may be started in 1016 prior to proceeding to 1018. Once in 1018, requests are sent for the siren solenoid driver to be turned on and the brake solenoid driver to be turned off.

The siren on timer is maintained outside of the automatic control mode for situations where, for example, the manual switch is held for 10 seconds with automatic mode switch open, and then the automatic mode switch is closed. Because the siren has been on for longer than ON_SEC (e.g., 5 seconds), it may not be driven immediately when the switch is closed.

However, if the brake switch is open in 1011 and the manual plus aux switch are both open in 1014, requests are sent for both solenoid drivers to be turned off in 1017. Accordingly, since the siren is now off, the siren on timer is then reset in 1019.

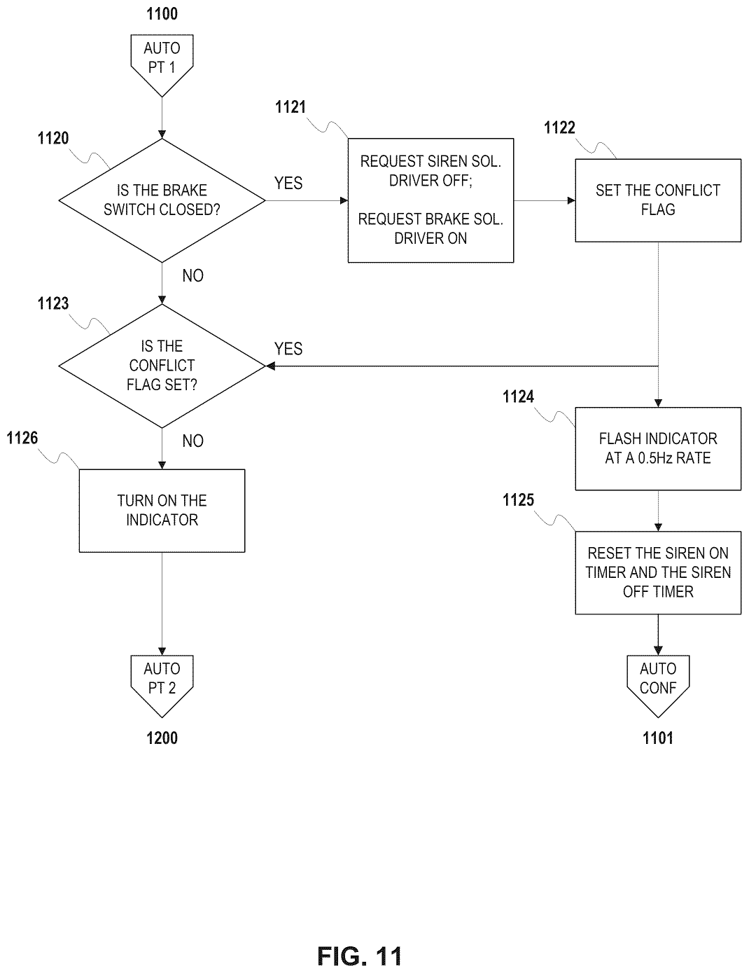

If the conditional test in 908 indicates that the auto mode switch is closed, FIG. 11 depicts the beginning of the automatic siren control.

Once the auto mode switch is closed, the state of the brake switch is determined in 1120. If the brake switch is closed and the automatic siren control switch is closed, the product is deemed to be in a conflicted state: the siren solenoid and brake solenoid should not be actuated together to ensure siren brake longevity, and the normal operation of the automatic control does not employ the brake solenoid. By actuating both switches, the operator's intention is not clear and the automatic control is disengaged even with the switch closed.

While the brake switch is closed, requests for the actions in 1121 may proceed: the siren solenoid driver may be shut off and the brake solenoid driver may turn on. The conflict flag may be set in 1122 to ensure that once the brake switch is opened, the conflict state persists. (The conflict is cleared in 909 once the auto mode switch is opened.)

If the brake switch is open in b20, but the flag has been set in 1123 from a previous conflict, the conflict operation continues. In 1124, the indicator is flashed at a 0.5 Hz rate and both the siren on timer and siren off timer are reset in 1125.

In the conflict state, execution then resumes at 1011 where the manual or aux (foot) switch can be used to manually turn on the siren solenoid driver.

If the brake switch has not been closed since the auto mode switch was closed, the conflict flag remains reset and the auto mode indicator may be turned on in 1126.

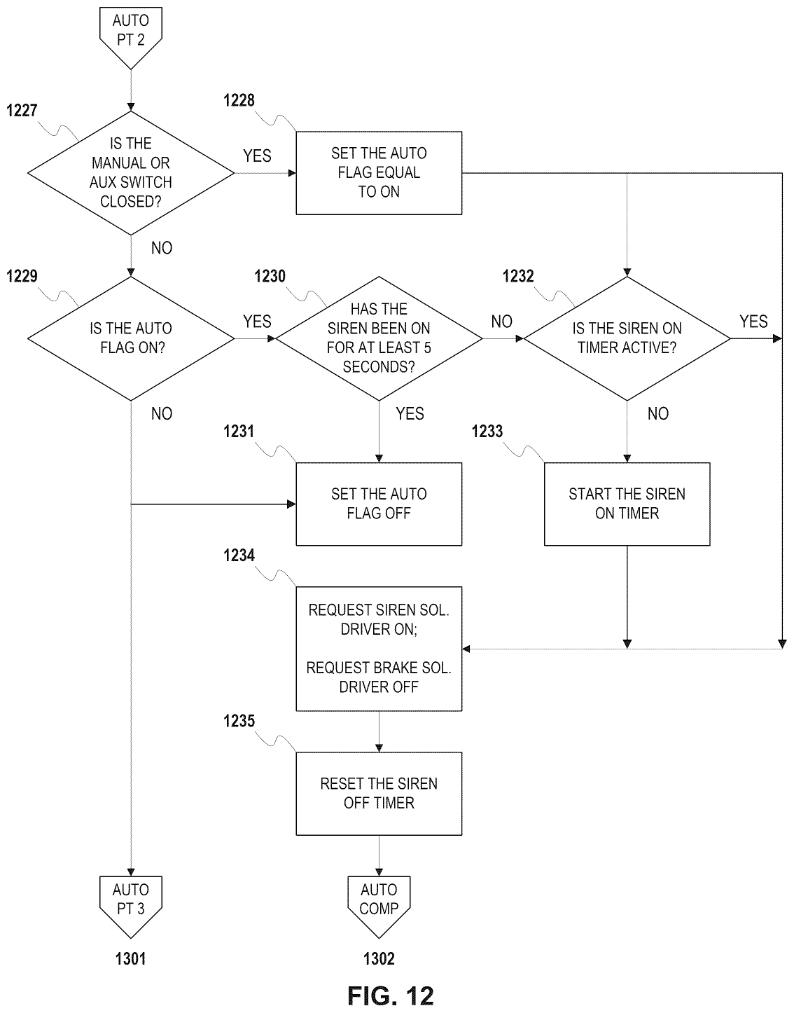

FIG. 12 illustrates the next section of the automatic mode operation, encompassing some of the siren on behavior. The manual and aux (foot) switches are tested in 1227 prior to the automatic mode operating normally. If either is closed, the auto flag is set to on in 1228. (The implied intention is that the operator desires to start another 5 second period with the siren solenoid driver actuated.) The siren on timer is tested in 1232; if it is not active, the timer may be started in 1233. Requests are sent for the siren solenoid driver to be turned on and the brake solenoid driver to be turned off in 1234. The siren off timer is reset in 1235 to coincide with the 5 second on period.

If, however, neither the manual nor aux (foot) switch is closed, the auto flag may be tested in 1229. If it is on, indicating that the siren is operating in the 5 second on portion of the siren control, execution proceeds to 1230 where the siren timer is examined. If it has been on for at least 5 seconds, the auto flag is set to off in 1231. Otherwise, execution proceeds to 1232 where the siren on timer and solid state load drivers are set correctly if needed. Note that it is possible for the operator to close the auto mode switch and hold the manual siren switch for, for example, 20 seconds. The siren solenoid may be driven for as long as the manual switch is held, exceeding the typical 5 second siren on period.

If the auto flag is off per 1229 or the auto flag has now been set to off in 1231, the 6 second off period may begin with FIG. 13. FIG. 13 illustrates the final section of the automatic mode operation, depicting the siren off behavior.

The siren off timer is checked in 1336. If the siren has not been off for 6 seconds, the timer may be tested in 1340 to ensure that it is started. If the siren off timer is not started, it may be in 1341; otherwise, the flowchart execution moves from 1340 to 1342. The siren solenoid driver and the brake solenoid driver are both shut off in 1342.

However, if the siren has been off for at least 6 seconds in 1336, the siren on timer is reset in 1338 and the auto flag is set to on in 1339. These two actions ensure that, at the next task iteration, the siren may be powered for at least 5 seconds.

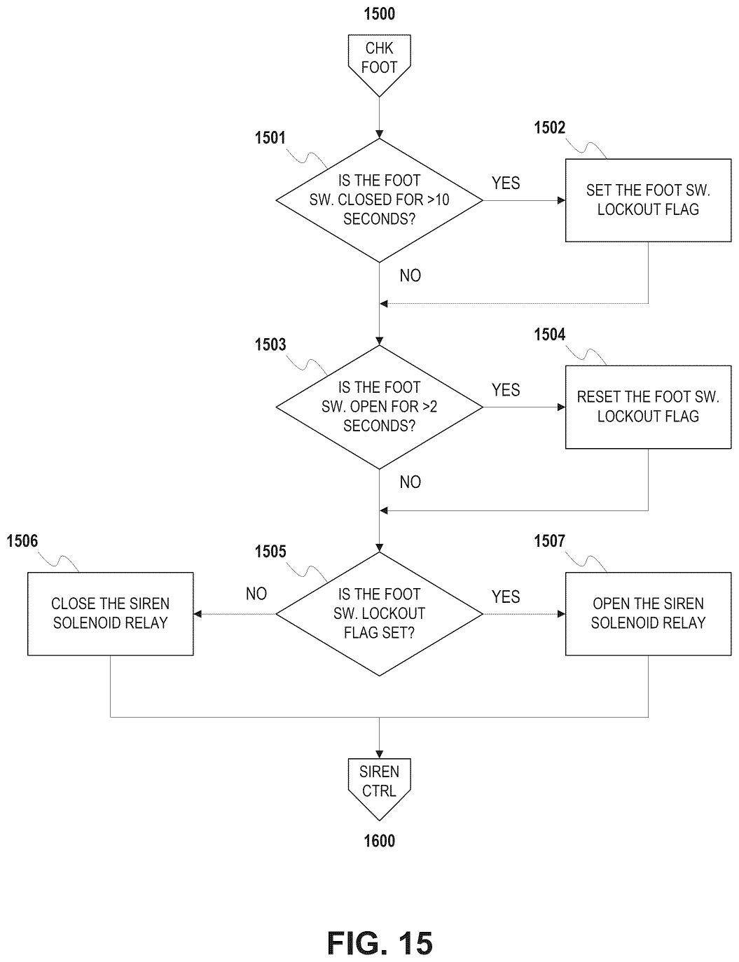

Regardless of the execution path taken to arrive at 1343, a final check is performed on the siren solenoid load driver. If an open circuit fault is indicated, either due to a miswiring, damaged wire, contaminated connection, blown fuse, or other reason, the indicator may be set to flash in a long/short pattern in 1344. (No open circuit diagnostics are performed on the brake solenoid since this is an optional component.) Should an error be detected with the foot pedal, the system may proceed to any of the actions depicted in FIG. 15-17.

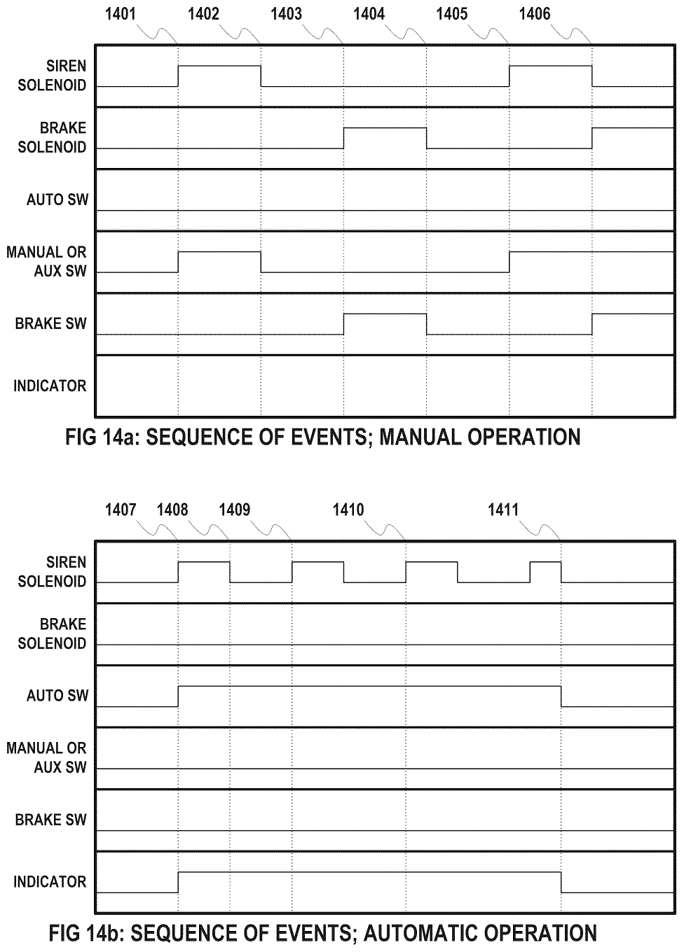

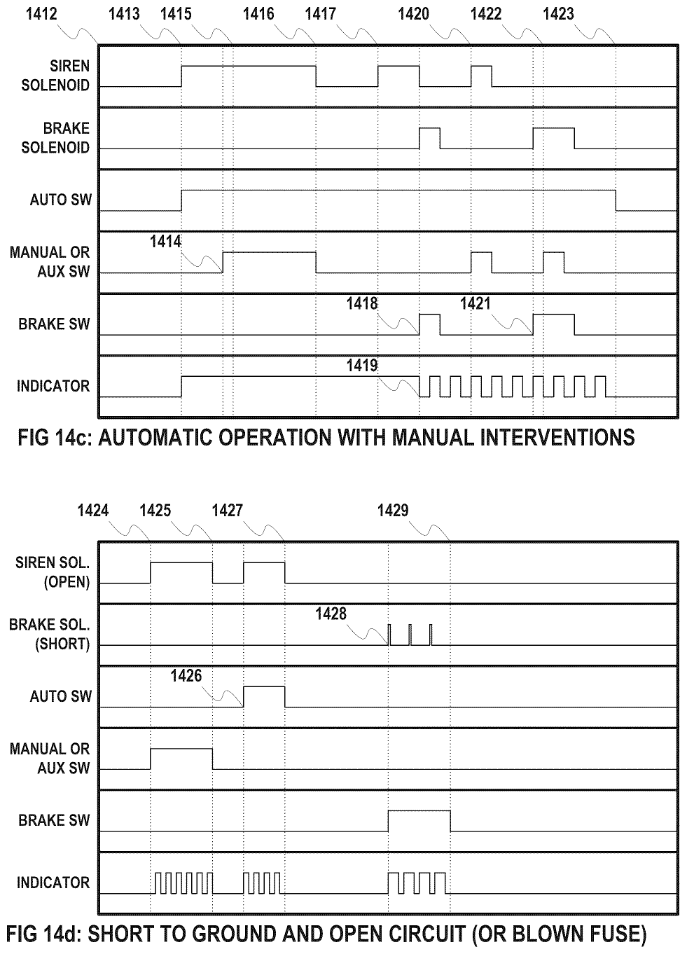

FIGS. 14A through 14D illustrate a sequence of events for normal operation and faulted operation according to some examples, in accordance with one or more techniques of the disclosure. These are merely examples, and the system described herein may produce alternate sequences of time and other operational timings. Rather, FIGS. 14A through 14D are simply one example set of timings for the purpose of relaying one possible arrangement. FIG. 14A depicts a sequence of events for manual operation. Note that there may be a propagation delay from switch measurement to solenoid actuation, but it is not depicted in these figures for simplicity.

The manual or aux (foot) switch is closed at time 1401 and opened at time 1402; the siren solenoid driver follows the switch state via firmware coupling. The brake switch is closed at time 1403 and opened at time 1404; the brake solenoid driver follows the switch state via firmware coupling.

The manual or aux (foot switch) is closed at time 1405 and the brake switch is closed at time 1406. Both remain closed up to the end of the sequence of events. The siren solenoid driver is opened at time 1406 to prioritize the brake solenoid (due to the high incidence of foot switches that fail closed) and prevent damage to the siren. The indicator remains off for this sequence of events.

FIG. 14B depicts a sequence of events for automatic operation with no user intervention on the manual control switches. (Note that there is a propagation delay from switch measurement to solenoid actuation, but it is not depicted in these figures for simplicity.) The auto mode switch is closed at time 1407 and opened at time 1411. The siren solenoid driver is on for 5 seconds starting at time 1407 and ending at time 1408. The driver remains off for 6 seconds until time 1409. The siren solenoid driver repeats another period of 5 seconds on and 6 seconds off, ending at 1410.

The auto mode switch is opened at 1411 before a full 5 second on portion of the cycle is complete; the siren solenoid driver is shut off when the auto mode switch is shut off. The indicator may remain on while the auto mode switch is closed.

FIG. 14C depicts a sequence of events 1412 for automatic operation with user intervention via the manual control switches. Note that there is a propagation delay from switch measurement to solenoid actuation, but it is not depicted in these figures for simplicity.

The auto mode switch is closed at time 1413. At time 1414, the manual or aux (foot switch) is also closed.

The 5 second on portion of the auto mode operation has expired by time 1415, but the siren solenoid driver remains on because the operator has closed one of the manual siren control switches.

The manual control switch is released at time 1416, and the siren solenoid driver is opened. The 6 second off period begins here and concludes at time 1417 whereupon the siren is turned back on for an intended 5 second period of operation.

The brake switch is closed at time 1418, prior to the 5 second on period finishing. This triggers the 0.5 Hz flash rate of the indicator at time 1419, depicting that the conflict flag is set. No further automatic operation may continue until the auto mode switch is opened and closed again.

The manual siren control switch is closed briefly starting at time 1420, and the siren solenoid driver is actuated accordingly. At time 1421, the brake switch is closed and the brake solenoid driver is actuated. With the brake switch still closed, the manual or aux (foot) switch is closed briefly starting at 1422. While both switches are closed, the brake solenoid driver remains on. At time 1423, the auto mode switch is opened and the indicator ceases flashing.

FIG. 14D depicts a sequence of events for faulted drivers. Note that there may be a propagation delay from switch measurement to solenoid actuation, but it is not depicted in these figures for simplicity.

In this sequence of events, the siren solenoid driver has an open circuit (or blown fuse) and the brake solenoid driver is shorted to ground (or has an overcurrent when actuated).

Time manual or aux (foot) switch is closed at time 1424. The load switch driver is actuated, the open circuit is detected, and the indicator is flashed at a 1 Hz rate until time 1425 when the switch is opened.

At time 1426, the auto mode switch is closed. The observed behavior is identical to the manual siren operation; the auto mode switch is opened at time 1427 and the indicator shuts off.

At time 1428, the brake switch is closed. In this example, the solid state load switch driver contains internal overcurrent and thermal protection features. With a constant assertion from the microcontroller to stay on, the load switch may automatically detect the overcurrent condition and shut off before internal damage or stress occurs. The part may remain off afterward to ensure thermal limits are not exceeded. This cycle repeats with periodicity, representing a hiccup mode as long as the signal remains asserted during a fault. The fault signal generated by the load switch is detected by the microcontroller. In another example, this hiccup behavior could be implemented by firmware.

While the overcurrent condition is reported by the load switch driver, the indicator produces a long-short on-off repeating pattern until the brake switch is opened at time 1429. To keep complexity manageable, FIG. 14A through FIG. 14D do not depict the possible decoupling between either siren solenoid driver request and siren solenoid driver state or brake solenoid driver request and brake solenoid driver state.

FIG. 15 through FIG. 17 illustrate flowcharts that depict error states that could be experienced by the siren driver, in accordance with one or more techniques of this disclosure. According to FIG. 15, if the foot switch is held for more than 10 seconds continuously, it is presumed to be in a failure state (stuck closed). In this instance, a lockout flag is set, and an NC relay (which provides a direct electrical connection between the foot switch and the siren solenoid) is opened. The lockout flag is cleared if the foot switch is open continuously for 2 seconds.

The duration that the foot switch has been continuously closed is checked in 1501. If it has been closed for longer than 10 seconds, a lockout flag is set in 1502. This flag is cleared in 1504 only if the foot switch has been continuously open for two seconds as determined in 1503.

This check ensures that a foot switch that has failed closed does not result in a siren that is continuously on. In 1505, the state of this flag either closes (in 1506, if lockout flag is clear) or opens (in 1507, if lockout flag is set) a relay that provides a direct electrical connection between the foot switch and the siren solenoid. In normal operation, there is no disadvantage to leaving this NC relay closed since the siren solenoid command will follow the foot switch. This NC relay provides safety guarantees against specific types of electronic failures as well.

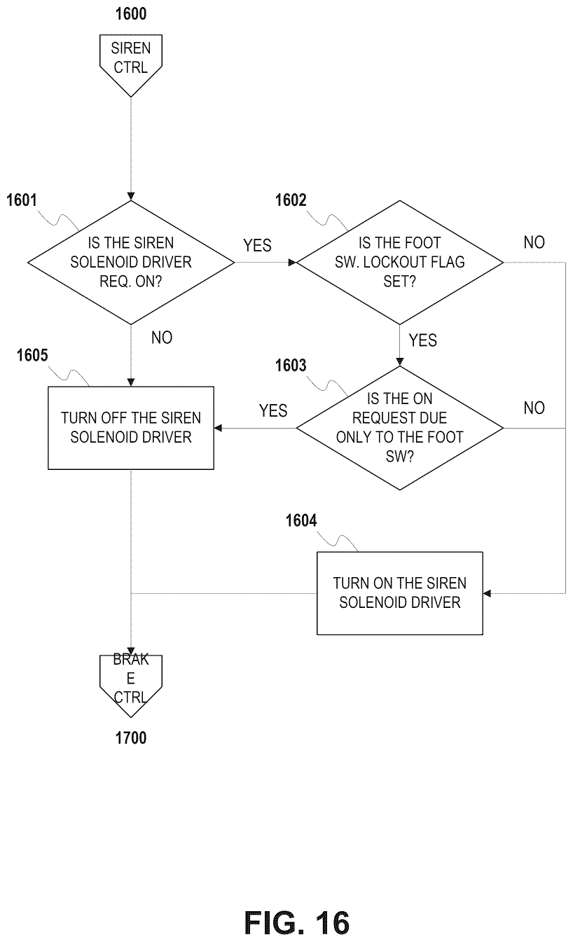

According to FIG. 16, if the driver is requested on and the lockout flag is clear (or it is requested on with lockout flag set, but the requesting source is not the foot switch), the siren solenoid driver is turned on; otherwise, it is turned off. This ensures that a broken foot switch will not cause the siren to run indefinitely.

If the siren solenoid driver is requested on in 1601, the state of the foot switch lockout flag is evaluated in 1602. If the foot switch is lockout flag is clear, the solenoid is turned on per the request in 1604. If the flag is set, the request source is evaluated in 1603; if the siren solenoid actuation request is from any source other than the foot switch, the siren solenoid driver will be turned on. However, if the lockout flag is set and the solenoid request is from the foot switch, the solenoid driver will remain off in 1605. If the solenoid driver is requested off in 1601, it will also remain off per 1605.

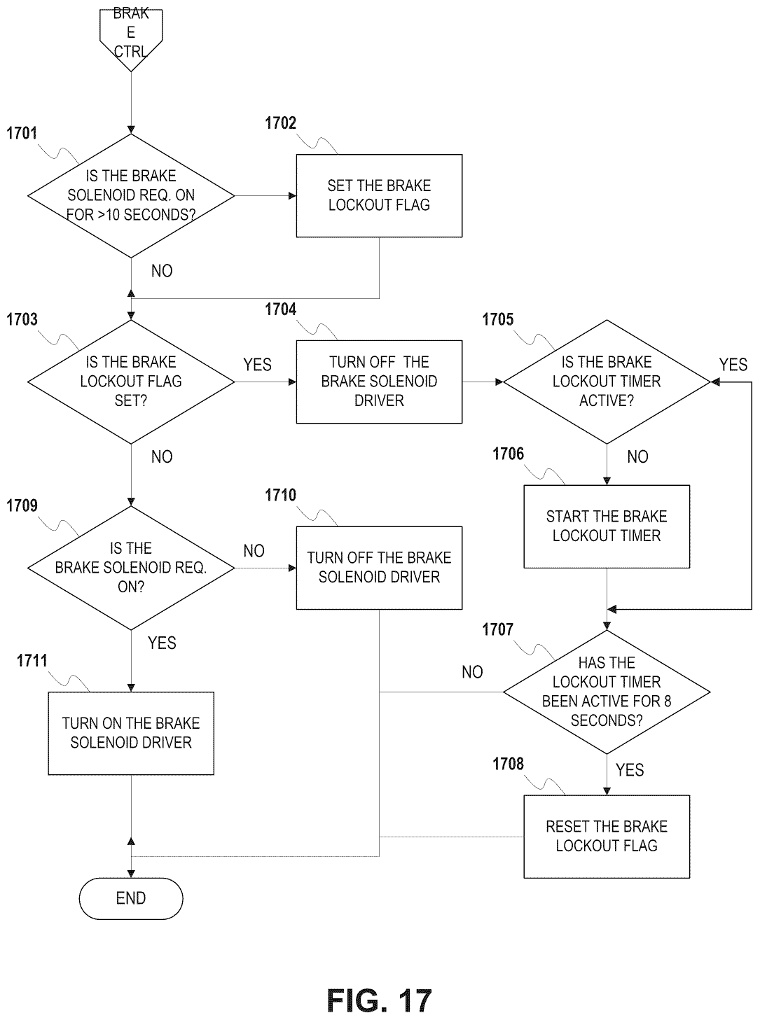

According to FIG. 17 if the brake solenoid is requested on for more than 10 seconds continuously, it is presumed to be a switch failure or possibly the installer did not use a momentary switch (and the switch remains in the closed position). After this threshold is met, the brake solenoid is switched off for 8 seconds. This forces a duty cycle of 10 seconds on, 8 seconds off if the switch is held closed; these times are adjustable. This protects the CAM-Driver (excessive heat) and the siren brake solenoid. Although not explicitly written in the flowchart, it may be prudent to report a stuck brake switch via a flashing indicator (and disable the brake until the switch is measured open again) if it is stuck for more than 30 seconds continuously.

The duration that the brake solenoid driver has been continuously requested on is checked in 1701. If the request exceeds 10 seconds, the brake lockout flag is set in 1702. The state of the flag is checked in 1703. If it is set, the brake solenoid is forced off in 1704 and a lockout timer is started in 1706 if it is not running as checked in 1705. This timer is checked in 1707; if it has been running for 8 seconds, the lockout flag is released. This behavior ensures that the brake solenoid has a guaranteed cooldown period of 8 seconds if it has been active for 10 seconds. Specific implementations may implement a ramp-up/ramp-down behavior on the brake solenoid request instead of a continuous time check.

If the lockout flag is clear when checked in 1703, the brake solenoid driver is turned on in 1711 if requested on and turned off in 1710 if requested off.

Example 1. A system comprising: an electromechanical siren comprising a siren and an electric motor; an automatic operation switch; and one or more processors configured to: when a user activates the automatic operation switch from an open position to a closed position, receive an indication of the automatic operation switch being activated into the closed position; in response to receiving the indication of the automatic operation switch being activated: activate the electric motor such that the electric motor drives the siren of the electromechanical siren; allow the electric motor to run for a first non-zero duration of time; and while the automatic operation switch remains in the closed position, and after the expiration of the first non-zero duration of time: deactivate the electric motor such that the electric motor ceases to drive the siren of the electromechanical siren; and allow the electric motor to stay deactivated for a second non-zero duration of time.

Example 2. The system of Example 1, wherein the processors are further configured to, while the automatic operation switch remains in the closed position, and after the expiration of the second non-zero duration of time: activate the electric motor such that the electric motor drives the siren of the electromechanical siren; and allow the electric motor to run for an additional instance of the first non-zero duration of time.

Example 3. The system of any one or more of Examples 1-2, wherein the first non-zero duration of time and the second non-zero duration of time are defined by emergency operational standards.

Example 4. The system of any one or more of Examples 1-3, further comprising: a manual operation switch; and one or more brake solenoids, wherein the one or more processors are further configured to, while the automatic operation switch is in the open position: when the user places the manual operation switch into a first position: receive an indication of the manual operation switch being activated into the first position; and in response to receiving the indication of the manual operation switch being activated into the first position, activate the electric motor such that the electric motor drives the siren of the electromechanical siren so long as the manual operation switch remains activated into the first position; and when the user places the manual operation switch into a second position: receive an indication of the manual operation switch being activated into the second position; and in response to receiving the indication of the manual operation switch being activated into the first position: deactivate the electric motor such that the electric motor ceases to drive the siren of the electromechanical siren while the manual operation switch remains in the second position; and activate at least one of the one or more brake solenoids to slow the siren.

Example 5. The system of any one or more of Examples 1-4, further comprising a normally closed relay electrically coupled between a foot switch and a siren solenoid, wherein the one or more processors are configured to open the normally closed relay in response to detecting that the foot switch has remained continuously activated for a predetermined duration.

Example 6. The system of any one or more of Examples 1-5, wherein the one or more processors are further configured to: analyze circuitry of the system and compare a current state of the circuitry to an expected state of the circuitry based on positions of any switch in the system.

Example 7. The system of any one or more of Examples 1-6, wherein the one or more processors are further configured to: diagnose one or more errors in the system, wherein the one or more errors include any one or more of: a stuck switch, a short-to-ground condition, and an overcurrent condition.

Example 8. The system of any one or more of Examples 1-7, wherein the automatic operation switch comprises any one or more of: a mechanical switch, a graphical icon within a graphical user interface output on a user interface component.

Example 9. The system of any one or more of Examples 1-8, wherein the automatic operation switch is not electrically coupled directly to the electric motor.

Example 10. The system of any one or more of Examples 1-9, wherein the system is integrated into an emergency vehicle.

Example 11. The system of any one or more of Examples 1-9, wherein the system is integrated into a stationary emergency notification structure.

Example 12. The system of any one or more of Examples 1-11, further comprising: two or more timer switches, wherein a setting of a first timer switch of the two or more timer switches defines the first non-zero duration of time, and wherein a setting of a second timer switch of the two or more timer switches defines the second non-zero duration of time.

Example 13. The system of Example 12, wherein each of the two or more timer switches are rotary dual inline package (DIP) switches.

Example 14. The system of any one or more of Examples 1-13, further comprising a brake solenoid and a lockout timer, wherein the one or more processors are configured to, in response to detecting that the brake solenoid has been continuously actuated for a first threshold duration, deactivate the brake solenoid for a second threshold duration.

Example 15. The system of any one or more of Examples 1-14, wherein the one or more processors are configured to, in response to detecting that the foot switch has transitioned from a continuously activated state to a continuously deactivated state for a predetermined reset duration, clear a lockout flag and re-enable actuation of the siren solenoid via the foot switch.

Example 16. The system of any one or more of Examples 1-15, wherein the one or more processors are configured to, in response to detecting that the brake solenoid has been continuously actuated for a third threshold duration exceeding the first threshold duration, generate a diagnostic indication of a stuck brake switch and disable actuation of the brake solenoid until the brake switch is measured open.

Example 17. The system of any one or more of Examples 1-16, wherein the one or more processors are configured to adjust the first non-zero duration of time and the second non-zero duration of time based on user input received from rotary switches or a graphical user interface.

Example 18. The system of any one or more of Examples 1-17, wherein the one or more processors are configured to monitor a voltage divider circuit to detect undervoltage and overvoltage conditions, and in response to detecting such conditions, deactivate the siren and solenoids to prevent battery drain or component damage.

Example 19. A method for performing any of the techniques of any combination of Examples 1-18.

Example 20. A device configured to perform any of the techniques of any combination of Examples 1-18.

Example 21. An apparatus comprising means for performing any of the techniques of any combination of Examples 1-18.

Example 22. A non-transitory computer-readable storage medium having stored thereon instructions that, when executed, cause one or more processors of a computing device to perform the techniques of any combination of Examples 1-18.

Example 23. A system comprising one or more computing devices configured to perform the techniques of any combination of Examples 1-18.

Example 24. Any of the techniques described herein.

Some acronyms used herein:
ADC—Analog to Digital Converter
CAN—Controller Area Network
FET—Field Effect Transistor
FPGA—Field Programmable Gate Array
IC—Integrated Circuit
PCB—Printed Circuit Board
PCB-A—Printed Circuit Board Assembly
PAL—Programmable Array Logic
PLA—Programmable Logic Array
RAM—Random Access Memory

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4,from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A system comprising:
an electromechanical siren comprising a siren and an electric motor;
an automatic operation switch; and
one or more processors configured to:
when a user activates the automatic operation switch from an open position to a closed position, receive an indication of the automatic operation switch being activated into the closed position;
in response to receiving the indication of the automatic operation switch being activated:
activate the electric motor such that the electric motor drives the siren of the electromechanical siren;
allow the electric motor to run for a first non-zero duration of time; and
while the automatic operation switch remains in the closed position, and after the expiration of the first non-zero duration of time:
deactivate the electric motor such that the electric motor ceases to drive the siren of the electromechanical siren; and
allow the electric motor to stay deactivated for a second non-zero duration of time.

2. The system of claim 1, wherein the processors are further configured to, while the automatic operation switch remains in the closed position, and after the expiration of the second non-zero duration of time:
activate the electric motor such that the electric motor drives the siren of the electromechanical siren; and
allow the electric motor to run for an additional instance of the first non-zero duration of time.

3. The system of claim 1, wherein the first non-zero duration of time and the second non-zero duration of time are defined by emergency operational standards.

4. The system of claim 1, further comprising:
a manual operation switch; and
one or more brake solenoids,
wherein the one or more processors are further configured to, while the automatic operation switch is in the open position:
when the user places the manual operation switch into a first position:
receive an indication of the manual operation switch being activated into the first position; and
in response to receiving the indication of the manual operation switch being activated into the first position, activate the electric motor such that the electric motor drives the siren of the electromechanical siren so long as the manual operation switch remains activated into the first position; and
when the user places the manual operation switch into a second position:
receive an indication of the manual operation switch being activated into the second position; and
in response to receiving the indication of the manual operation switch being activated into the first position:
deactivate the electric motor such that the electric motor ceases to drive the siren of the electromechanical siren while the manual operation switch remains in the second position; and
activate at least one of the one or more brake solenoids to slow the siren.

5. The system of claim 1, further comprising a normally closed relay electrically coupled between a foot switch and a siren solenoid, wherein the one or more processors are configured to open the normally closed relay in response to detecting that the foot switch has remained continuously activated for a predetermined duration.

6. The system of claim 1, wherein the one or more processors are further configured to:
analyze circuitry of the system and compare a current state of the circuitry to an expected state of the circuitry based on positions of any switch in the system.

7. The system of claim 1, wherein the one or more processors are further configured to:
diagnose one or more errors in the system, wherein the one or more errors include any one or more of:
a stuck switch,
a short-to-ground condition, and
an overcurrent condition.

8. The system of claim 1, wherein the automatic operation switch comprises any one or more of:
a mechanical switch,
a graphical icon within a graphical user interface output on a user interface component.

9. The system of claim 1, wherein the automatic operation switch is not electrically coupled directly to the electric motor.

10. The system of claim 1, wherein the system is integrated into an emergency vehicle.

11. The system of 1, wherein the system is integrated into a stationary emergency notification structure.

12. The system of claim 1, further comprising:
two or more timer switches, wherein a setting of a first timer switch of the two or more timer switches defines the first non-zero duration of time, and wherein a setting of a second timer switch of the two or more timer switches defines the second non-zero duration of time.

13. The system of claim 12, wherein each of the two or more timer switches are rotary dual inline package (DIP) switches.

14. The system of claim 1, further comprising a brake solenoid and a lockout timer, wherein the one or more processors are configured to, in response to detecting that the brake solenoid has been continuously actuated for a first threshold duration, deactivate the brake solenoid for a second threshold duration.

15. The system of claim 1, wherein the one or more processors are configured to, in response to detecting that the foot switch has transitioned from a continuously activated state to a continuously deactivated state for a predetermined reset duration, clear a lockout flag and re-enable actuation of the siren solenoid via the foot switch.

16. The system of claim 1, wherein the one or more processors are configured to, in response to detecting that the brake solenoid has been continuously actuated for a third threshold duration exceeding the first threshold duration, generate a diagnostic indication of a stuck brake switch and disable actuation of the brake solenoid until the brake switch is measured open.

17. The system of claim 1, wherein the one or more processors are configured to adjust the first non-zero duration of time and the second non-zero duration of time based on user input received from rotary switches or a graphical user interface.

18. The system of claim 1, wherein the one or more processors are configured to monitor a voltage divider circuit to detect undervoltage and overvoltage conditions, and in response to detecting such conditions, deactivate the siren and solenoids to prevent battery drain or component damage.

19. A method comprising:
providing an electromechanical siren comprising a siren and an electric motor;
providing an automatic operation switch;
receiving, by one or more processors, an indication that a user has activated the automatic operation switch from an open position to a closed position;
in response to receiving the indication of the automatic operation switch being activated into the closed position, activating the electric motor such that the electric motor drives the siren of the electromechanical siren;
allowing the electric motor to run for a first non-zero duration of time;
while the automatic operation switch remains in the closed position, and after the expiration of the first non-zero duration of time, deactivating the electric motor such that the electric motor ceases to drive the siren of the electromechanical siren; and
allowing the electric motor to stay deactivated for a second non-zero duration of time.

20. A non-transitory computer-readable storage medium having stored thereon instructions that, when executed, cause one or more processors of a computing device to:
receive an indication that a user has activated an automatic operation switch from an open position to a closed position;
in response to receiving the indication of the automatic operation switch being activated into the closed position, activate an electric motor such that the electric motor drives a siren of an electromechanical siren;
allow the electric motor to run for a first non-zero duration of time;
while the automatic operation switch remains in the closed position, and after the expiration of the first non-zero duration of time, deactivate the electric motor such that the electric motor ceases to drive the siren of the electromechanical siren; and
allow the electric motor to stay deactivated for a second non-zero duration of time.
